(19) United States
(12) Patent Application Publication
(10) Pub. No.: US 2026/0221437 A1
(43) Pub. Date: Jul. 30, 2026

(54) POSITIVE ELECTRODE ACTIVE MATERIAL FOR LITHIUM-ION BATTERIES, BATTERY COMPRISING THE SAME, AND USE THEREOF

(71) Applicant: Umicore, Brussels (BE)

(72) Inventors: Liang ZHU, Brussels (BE); Olesia KARAKULINA, Chungcheongnam-do (KR); JiYoung BAE, Chungcheongnam-do (KR); SoYon LEE, Chungcheongnam-do (KR)

(21) Appl. No.: 19/143,464

(22) PCT Filed: Dec. 21, 2023
(86) PCT No.: PCT/EP2023/087191

§ 371 Date: Jun. 26, 2025

(30) Foreign Application Priority Data
Dec. 27, 2022 (EP) 22216693.6

(51) Int. Cl. H01M 4/525; B60L 50/64; C01G 53/42; C01G 53/506

(52) U.S. Cl. CPC H01M 4/525; B60L 50/64; C01G 53/42; C01G 53/506; C01P 2002/50; C01P 2002/52; C01P 2002/60; C01P 2004/03; C01P 2004/61; C01P 2004/62; C01P 2004/64; C01P 2006/12; C01P 2006/40; H01M 2220/20

(57) ABSTRACT

The present invention relates to a positive electrode active material for lithium-ion batteries, wherein the positive electrode active material comprises secondary particles comprising primary particles, wherein the primary particles have an average primary particle size (S1) as determined by SEM image analysis, wherein the positive electrode active material has an average crystallite size (S2) as determined by X-Ray Diffraction measurement, wherein S1/S2 is at least 13, and wherein the positive electrode active material has been treated with an aqueous solution.

### TECHNICAL FIELD AND BACKGROUND

The present invention relates to a positive electrode active material for lithium-ion batteries. More specifically, the present invention relates to a positive electrode active material for lithium-ion batteries, wherein the positive electrode active material comprises secondary particles comprising primary particles, wherein some factors to cause poor battery performance such as a high amount of lithium impurities, a high moisture content and a high specific surface area of the positive electrode active material are reduced. The present invention also relates to a battery comprising the positive electrode active material, and use of a battery comprising the positive electrode active material.

It is well known that lithium impurities such as LiOH and/or Li₂CO₃ are often generated during a process of preparing a positive electrode active material for lithium-ion batteries, especially when the positive electrode active material has a Ni content of at least 60 atomic % (at %). In order to reduce the lithium impurities on a surface of the positive electrode active material, the positive electrode active material is treated with aqueous solution. As a result of the aqueous solution treatment, a specific surface area of the positive electrode material increases. However, the increased specific surface area leads to undesired side reactions between the positive electrode active material and electrolyte, which cause a poor battery cycle life. Also, the increased specific surface area of the positive electrode active material may lead to an increase of moisture content on the surface of the positive electrode active material. Accordingly, a positive electrode active material with a low amount of lithium impurities, a low moisture content and a low specific surface area is required.

It is a first object of the present invention to provide a positive electrode active material with a low amount of lithium impurities, a low moisture content and a low specific surface area.

It is a second object of the present invention to provide a battery comprising the above-mentioned positive electrode active material.

It is a third object of the present invention to provide a use of the above-mentioned battery in an electric vehicle or in a hybrid electric vehicle.

### ACKNOWLEDGMENT

This invention was made with the support from Materials/Parts Technology Development Program through Korea evaluation institute of industrial technology funded by Ministry of Trade, Industry and Energy (MOTIE, Republic of Korea). [Project Name: Development of high power (high discharge rate) lithium-ion secondary batteries with 8C-rate class/Project Number: 20011287/Contribution rate: 100%]

### SUMMARY OF THE INVENTION

The first object of the present invention is achieved by providing a positive electrode active material for lithium-ion batteries, wherein the positive electrode active material comprises secondary particles comprising primary particles, wherein the primary particles have an average primary particle size (S1) as determined by SEM image analysis, wherein the positive electrode active material has an average crystallite size (S2) as determined by X-Ray Diffraction measurement, wherein S1/S2 is at least 13, and wherein the positive electrode active material has been treated with an aqueous solution.

The second object of the present invention is achieved by providing a battery comprising the above-mentioned positive electrode active material.

The third object of the present invention is achieved by providing a use of the above-mentioned battery in an electric vehicle or in a hybrid electric vehicle.

### BRIEF DESCRIPTION OF THE FIGURES

FIG. 1a is a SEM image of EX2.1 showing the secondary particle comprising a plurality of primary particles. Dotted line shows the area to be captured in order to obtain the average primary particle diameter of the secondary particle.

FIG. 1b is a SEM image of EX2.1 to obtain the average primary particle diameter of the secondary particle of EX2.1.

FIG. 2 is a SEM image of Precursor B to obtain the average primary particle diameter of Precursor B.

FIG. 3 is a SEM image of Precursor A to obtain the average primary particle diameter of Precursor A.

FIG. 4 is a SEM image of Precursor C to obtain the average primary particle diameter of Precursor C.

FIG. 5 is a SEM image of Precursor D to obtain the average primary particle diameter of Precursor D.

### DETAILED DESCRIPTION OF THE INVENTION

In the following detailed description, preferred embodiments are described in detail to enable practice of the present invention. Although the present invention is described with reference to these specific preferred embodiments, it will be understood that the present invention is not limited to these preferred embodiments. In contrast, the present invention includes numerous alternatives, modifications and equivalents as will become apparent from consideration of the following detailed description.

### Positive Electrode Active Material

In a first aspect, the present invention relates to a positive electrode active material for lithium-ion batteries, wherein the positive electrode active material comprises secondary particles comprising primary particles, wherein the primary particles have an average primary particle size (S1) as determined by SEM image analysis, wherein the positive electrode active material has an average crystallite size (S2) as determined by X-Ray Diffraction measurement, and wherein S1/S2 is at least 13.

The inventors of the present invention have found that decreases in an amount of lithium impurities, a moisture content and a specific surface area of a positive electrode active material are achieved by adjusting S1/S2 of the positive electrode active material. S1/S2 may be adjusted to be at least 13. That is, the amount of lithium impurities, the moisture content and the specific surface area of the positive electrode active material having S1/S2 of at least 13 (“CAM1”) are lower than an amount of lithium impurities, a moisture content and a specific surface area of a positive electrode active material having S1/S2 of below 13 (“CAM2”), wherein CAM1 and CAM2 have the same metal composition. The lithium impurities in the positive electrode active material may be LiOH and/or Li₂CO₃.

The primary particle size, the average of which is S1, is calculated by using ImageJ software (ImageJ 1.52a, National Institutes of Health, USA). The specific method of calculating the primary particle size is described in the following section, “Experimental Methods Used in The Examples, E) Particle Size, E2) Primary Particle Size Analysis of Positive Electrode Active Material.”

The average crystallite size, i.e., S2, is determined by XRD measurement of the secondary particles of the positive electrode active material. The specific method of determining S2 is described in the following section, “Experimental Methods Used in The Examples, F) X-Ray Powder Diffraction, F2) Crystallite Size Calculation.”

The amount of the lithium impurities of the positive electrode active material is determined by measuring a soluble base content by pH titration. The soluble base content refers to a content of a base in an aqueous solution, which has been formed by dissolving the positive electrode active material, which contains the base and has not been treated with aqueous solution, in deionized water. The soluble base content increases as a Ni content of the positive electrode active material increases. The specific method of measuring the soluble base content is described in the following section, “Experimental Methods Used In The Examples, B) Surface Base Analysis.”

The moisture content of the positive electrode active material is measured by Karl Metrohm Fischer Coulometer. The moisture content increases as a Ni content of the positive electrode active material increases. The specific method of measuring the moisture content is described in the following section, “Experimental Methods Used in The Examples, C) Moisture Analysis.”

In a preferred embodiment, S1/S2 may be between 15 and 40, preferably between 17 and 30.

In a preferred embodiment, S1 may range from 100 nm to 1000 nm, preferably from 200 nm to 800 nm, more preferably from 300 nm to 600 nm.

In a preferred embodiment, S2 may range from 5 nm to 50 nm, preferably from 10 nm to 40 nm, more preferably from 15 nm to 35 nm.

In a preferred embodiment, the positive electrode active material may be treated with an aqueous solution and then dried. Treating the positive electrode active material with the aqueous solution may be conducted by immersing the positive electrode active material in the aqueous solution. The specific surface area of the positive electrode active material increases by the abovementioned treatment.

In a preferred embodiment, the positive electrode active material, which has been treated with an aqueous solution, may have a specific surface area of at most 3.5 m²/g, preferably at most 3.3 m²/g, and at least 2.0 m²/g, preferably at least 2.5 m²/g as determined by BET method. The BET method is specifically described in the following section, “Experimental Methods Used In The Examples, D) Specific Surface Area Analysis.”

In a preferred embodiment, the positive electrode active material comprises Li, M′, and oxygen, wherein M′ comprises:
Ni in a content x, wherein x≥60.0 at %, relative to M′;
Co in a content y, wherein 0.0≤y≤30.0 at %, relative to M′;
Mn in a content z, wherein 0.0≤z≤30.0 at %, relative to M′;
D in a content a, wherein 0.0≤a≤5.0 at %, relative to M′, wherein D is at least one element selected from the group consisting of Al, B, Ba, Ca, Cr, Fe, Mg, Mo, Nb, S, Si, Sr, Ti, Y, V, W, Zn, and Zr;
wherein x+y+z+a is 100.0 at %.

In certain preferred embodiments D is at least one element selected from the group consisting of Al, B, Ba, Ca, Ce, Cr, Fe, Mg, Mo, Nb, S, Si, Sr, Ti, Y, V, W, Zn, and Zr.

In the foregoing embodiment, x may be preferably at least 70.0 at %, more preferably at least 80.0 at %, most preferably at least 85.0 at %, relative to M′; y may be preferably above 0.0 at % and 10.0 at % or less, more preferably above 2.0 at % and 8.0 at % or less, most preferably above 3.0 at % and 6.0 at % or less, relative to M′; and/or z may be preferably above 0.0 at % and 15 at % or less, more preferably above 2.0 at % and 13.0 at % or less, most preferably above 5.0 at % and 11.0 at % or less, relative to M′.

In the framework of the present invention, at % signifies atomic percentage. The at % or “atomic percent” of a given element means a percentage of atoms of said element among all atoms in a claimed composition. ICP-OES provides weight percent (wt %) of each element included in a material whose composition is determined by this technique. Conversion from wt % to at % is as follows:
at % of a first element E₁ (Eₐₜ₁) in a material can be converted from a given wt % of said first element E₁ (E_{wt1}) in said material by applying the following formula,

$${E}_{a t 1} = \frac{( {E}_{wt 1} / {E}_{a w 1} )}{{\sum }_{i = 1}^{n} ( {E}_{w t i} / {E}_{a w i} )} \times 100 \% ,$$

wherein E_{aw1} is a standard atomic weight of the first element E₁, E_{wt1} is wt % of an i^{th} element E₁, E_{aw1} is a standard atomic weight of said i^{th} element Eᵢ, and n is an integer which represents the number of types of all elements included in the material.

In a preferred embodiment, a median size D50 of the secondary particles of the positive electrode active material is at least 2.0 μm and at most 15.0 μm, as determined by laser diffraction particle size analysis.

In a preferred embodiment, the positive electrode active material may be represented by the general formula (I):

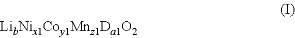

wherein x1+y1+z1+a1 is 1.00; x1≥0.6, preferably x1≥0.7, more preferably x1≥0.8, most preferably x1≥0.85; 0.0≤y1≤0.3, preferably 0.0≤y1≤0.1, more preferably 0.02≤y1≤0.08, most preferably 0.03≤y1≤0.06; 0.0≤z1≤0.3, preferably 0.0≤z1≤0.15, more preferably 0.02≤z1≤0.13, most preferably 0.05≤z1≤0.11; 0.00≤a1≤0.05, preferably 0.00≤a1≤0.04, more preferably 0.00≤a1≤0.03, most preferably 0.00≤a1≤0.02, 0.90≤b≤1.20, preferably 0.93≤b≤1.15, more preferably 0.95≤b≤1.10, most preferably 0.97≤b≤1.05, and D is an element selected from the group consisting of Al, B, Ba, Ca, Ce, Cr, Fe, Mg, Mo, Nb, S, Si, Sr, Ti, Y, V, W, Zn, and Zr.

The positive electrode active material corresponding to the present invention may be prepared by a process comprising:
supplying a flow of a metal salt solution comprising one or more metal elements to a reactor vessel for a time period (T1-T2);
mixing the metal salt solution with an aqueous solution comprising one or more alkali hydroxides and an aqueous solution of ammonia (NH₃(aq)) during the time period (T1-T2), thereby forming an aqueous slurry comprising hydroxide or oxyhydroxide particles of the one or more metal elements,
wherein during the time period (T1-T2), maintaining in the reactor vessel:
   a range of pH value of the aqueous slurry, the range being superior or equal to 11.5 and inferior or equal to 12.0, preferably superior or equal to 11.6 and inferior or equal to 11.9, wherein the pH value of the aqueous slurry is the pH value as measured on a sample of the aqueous slurry after cooling to 20° C.,
   a concentration of NH₃(aq) of superior or equal to 5.0 g/I and preferably inferior or equal to 15.0 g/l, and
   a temperature of the aqueous slurry which is at least 70° C. and which is at most 99° C.,
wherein after the time period (T1-T2), the aqueous slurry in the reactor vessel is further processed by separating a solid fraction from a liquid fraction and drying the solid fraction to obtain a secondary particles-based powderous material compound;
mixing a powderous material comprising the secondary particles-based powderous material compound, a lithium source, and an optional dopant source to obtain a mixture; and
heating the mixture in oxidizing atmosphere at a temperature between 650° C. to 1000° C. to obtain a raw positive electrode active material,
wherein the process optionally further comprises a heat treatment step before the step of mixing, wherein the powderous material is heated at a temperature of 105° C. to 750° C.

In a preferred embodiment, the process further comprises treating the raw positive electrode active material with an aqueous solution.

The pH value may be measured by using a pH meter, for example 780 Metrohm meter. The NH₃(aq) concentration may be measured by using a commercially available titrator, for example Metrhom 848 Titrino Plus.

The powderous material comprising the secondary particles-based powderous material compound in the process of preparing the positive electrode active material corresponding to the present invention is referred to as a precursor.

In the process of preparing the positive electrode active material corresponding to the present invention, the hydroxide may be partially oxidized, depending on the atmosphere of the manufacturing process. Thus, the aqueous slurry may contain oxyhydroxide. Also during drying the solid fraction, the hydroxide or oxyhydroxide particles from the aqueous slurry may be further partially oxidized. It is to be noted that an atmospheric condition is not essential to achieve the precursor.

The secondary particles-based powderous compound may be a M-hydroxide or M-oxyhydroxide, wherein M comprises one or more metal elements including at least one of Ni, Co and Mn,
wherein said secondary particles comprise a plurality of primary particles,
wherein the compound has a median particle size D50 between 3.0 μm and 20.0 μm as determined by laser diffraction,
wherein said primary particles have a particle-based thickness distribution as determined by measuring a primary particle thickness in an image taken by SEM, wherein said thickness distribution has a median particle thickness between 180 nm and 600 nm, and
wherein the compound has a span value (D90-D10)/D50 being at most 0.6, preferably at most 0.4, more preferably at most 0.2, and D10, D50, and D90 are the value of the particle diameter at 10%, 50% and 90%, respectively, in the cumulative distribution.

The primary particle thickness is calculated by using ImageJ software (ImageJ 1.52a, National Institutes of Health, USA). The specific method of calculating the primary particle thickness is described in the following section, “Experimental Methods Used in The Examples, E) Particle Size, E3) Primary Particle Size Analysis of Precursor, Step 1) to Step 4).” The corresponding thickness when a cumulative percentage of the thickness distribution reaches 50% is denoted as p50. Likewise, the corresponding thickness when a cumulative percentage of the thickness distribution reaches 75% is denoted as p75. The thickness distribution may have a p50 ranging between 200 nm and 580 nm, preferably between 220 nm and 570 nm. The thickness distribution may have a p75 ranging between 225 nm and 800 nm, preferably between 250 nm and 750 nm. The disclosed ranges of p50 and/or p75 may indicate a dense structure of the primary particle. The cumulative percentage of the thickness distribution is calculated based on the data of the primary particle thickness obtained by ImageJ software (ImageJ 1.52a, National Institutes of Health, USA). The specific method of calculating the cumulative percentage of the thickness distribution is described in the following section, “Experimental Methods Used in The Examples, E) Particle Size, E3) Primary Particle Size Analysis of Precursor, Step 5) and Step 6).”

### Battery

In a second aspect, the present invention relates to a battery comprising the positive electrode active material according to the first aspect.

### Use of Battery

In a third aspect, the present invention relates to a use of the battery according to the second aspect in an electric vehicle or in a hybrid electric vehicle.

As appreciated by a person skilled in the art, all embodiments directed to the positive electrode active material according to the first aspect may apply mutatis mutandis to the second and third aspects.

### EXPERIMENTAL METHODS USED IN THE EXAMPLES

The following analysis methods are used in the Examples:

A) Inductively coupled plasma-optical emission analysis (ICP-OES) The contents of the metal elements in the precursor and the positive electrode active material as described herein below are measured by the Inductively Coupled Plasma-Optical Emission Spectrometry (ICP-OES) method using an Agillent ICP 720-OES. 1 gram of a powder sample is dissolved into 50 mL high purity hydrochloric acid in an Erlenmeyer flask. The flask is covered by a watch glass and heated on a hot plate at 380° C. until complete dissolution of the sample. After being cooled to room temperature, the solution and the rinsing water of Erlenmeyer flask are transferred to a 250 mL volumetric flask. Afterwards, the volumetric flask is filled with DI water up to the 250 mL mark, followed by complete homogenization. An appropriate amount of solution is taken out by pipette and transferred into a 250 mL volumetric flask for the 2^{nd} dilution, where the volumetric flask is filled with internal standard and 10% hydrochloric acid up to the 250 mL mark and then homogenized. Finally, this solution is used for ICP-OES measurement. The content of each metal element is expressed as wt % of the total contents of the metal elements.
B) Surface base analysis

In the measurement of soluble base content by pH titration, two steps are performed: (a) the preparation of solution, and (b) pH titration. The detailed explanation of each step is as follows: Step (a): The preparation of solution: powder is immersed in deionized water and stirred for 10 min in a sealed glass flask containing 100 mL of deionized water. The amount of positive electrode active material powder, which has not been treated with aqueous solution, is 4 grams. After stirring, to dissolve the base, the suspension of powder in water is filtered to get a clear solution.

Step (b): pH titration: 90 mL of the clear solution prepared in step (a) is used for pH titration by using 0.1M HCl. The flow rate is 0.5 mL/min and the pH value is recorded each 3 seconds. The pH titration profile (pH value as a function of added HCl) shows two clear equivalence (or inflection) points. The first equivalence point (corresponding to a HCl quantity of EP1) at around pH 7.4 results from the reaction of OH⁻ and CO₃²⁻ with H⁺. The second equivalence point (corresponding to a HCl quantity of EP2) at around pH 4.7 results from the reaction of HCO₃⁻ with H⁺. It is assumed that the dissolved base in deionized water is either LiOH (with a quantity 2*EP1-EP2) or Li₂CO₃ (with a quantity 2*(EP2-EP1)). The obtained values for LiOH and Li₂CO₃ are the result of the reaction of the surface with deionized water.

### C) Moisture Analysis

The moisture content of the positive electrode active material powder is measured by Karl Metrohm Fischer Coulometer. 1 gram of the positive electrode active material powder is placed in the 300° C. KF furnace. The evaporated moisture is guided into the KF reactor and analyzed by KF coulometry.

D) Specific surface area analysis
D1) Measurement of specific surface area before treatment with aqueous solution

The specific surface area of the positive electrode active material is measured with the Braunaer-Emmet-Teller (BET) method by using a Micromeritics Tristar II 3020. A powder sample is heated at 300° C. under a nitrogen (N₂) gas for 1 hour prior to the measurement in order to remove adsorbed species. The dried powder is put into the sample tube. The sample is then de-gassed at 30° C. for 10 minutes. The instrument performs the nitrogen adsorption test at 77 K. By obtaining the nitrogen isothermal absorption/desorption curve, the total specific surface area of the sample in m²/g is derived.

D2) Measurement of Specific Surface Area after Treatment with Aqueous Solution

The specific surface area of the positive electrode active material treated with an aqueous solution is obtained by mixing 7 grams of positive electrode active material in 70 grams of water for 10 minutes followed by drying in the vacuum oven at 120° C. for 3 hours.

The specific surface area of the dried powder is measured with the Braunaer-Emmet-Teller (BET) method by using a Micromeritics Tristar II 3020. A powder sample is heated at 300° C. under a nitrogen (N₂) gas for 1 hour prior to the measurement in order to remove adsorbed species. The dried powder is put into the sample tube. The sample is then de-gassed at 30° C. for 10 minutes. The instrument performs the nitrogen adsorption test at 77 K. By obtaining the nitrogen isothermal absorption/desorption curve, the total specific surface area of the sample in m²/g is derived.

E) Particle size
E1) Secondary particle size analysis

The secondary particle size distribution for both a precursor and a positive electrode active material are measured using a Malvern Mastersizer 3000 with Hydro MV wet dispersion accessory after dispersing examples as described herein below of a powder of the precursor or the positive electrode active material in an aqueous medium. To improve the dispersion of the powder, sufficient ultrasonic irradiation and stirring is applied, and an appropriate surfactant is introduced. D50 is defined as the particle size at 50% of the cumulative volume % distribution.

E2) Primary particle size analysis of positive electrode active material

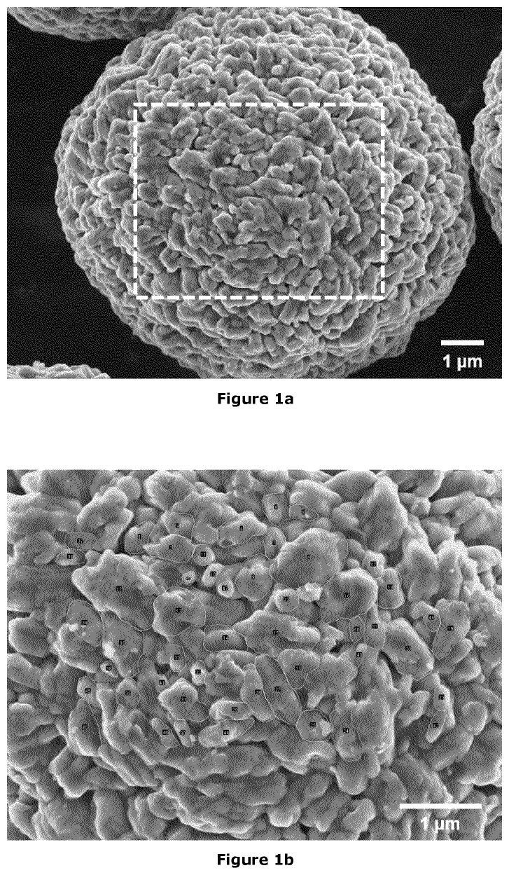

The diameter of primary particle of positive electrode active material is calculated by using ImageJ software (ImageJ 1.52a, National Institutes of Health, USA) according to the following steps:
Step 1) Open the file containing SEM image of positive electrode active material with 10,000 times magnification wherein the image is taken at the center part of a secondary particle. Example of such image is shown in FIG. 1a wherein the dotted line shows the area to be captured corresponding to FIG. 1b.
Step 2) Set scale according to the SEM magnification.
Step 3) Draw lines following primary particle edges using polygon selections tool for at least 50 particles. The particles at the edges of image are to be excluded if truncated.
Step 4) Measure the area of the drawn primary particles selected from Set Measurements and Area box.
Step 5) Calculate the particle diameter of each measured area by assuming the particle in the spherical shape following

$$d = 2 \times \sqrt{\frac{a r e a}{π}}$$

and obtain the average primary particle diameter (S1) for at least 50 particles.

### E3) Primary Particle Size Analysis of Precursor

The thickness of primary particle of precursor is calculated by using ImageJ software (ImageJ 1.52a, National Institutes of Health, USA) according to the following steps:
Step 1) Open the file containing SEM image of precursor material with 20,000 times magnification.
Step 2) Set scale according to the SEM magnification.
Step 3) Select Straight tool and place the line on the primary particle perpendicular with the orientation of the primary particle.
Step 4) Measure the thickness of the primary particles selected from Set Measurements and Area box. Thickness is indicated in the Length column.
Step 5) Repeat process 3 and 4 to randomly selected 90 particles in one image. Additional SEM image can be used if the number of particles in one image is less than 90. FIG. 2 shows the example of measurement of Precursor B.
Step 6) Process the data in Microsoft Excel or any number processing software according to the below steps which is illustrated in Table 1:
   a. Sort the primary particle thickness from lowest to highest in the “Thickness” column
   b. Calculate the fraction of each thickness contribution to the total sum of thickness in the “Fraction of total” column
   c. Calculate the cumulative fraction in the “cumulative” column
   d. Calculate p50 and p75 each by linear line equation y=mx+c from the two closest cumulative number.

TABLE 1
Example of p50 and p75 measurement for precursor of EX1

| Particle | Thickness | | | |
|---|---|---|---|---|
| number | (nm) | Fraction of total (%) | Cumulative (%) | |
| 1 | 18.2 | $= \frac{18.2}{22044.4} \times 100 \% = 0.08 \%$ | = 0.08 | |
| 2 | 22.1 | 0.10 | = 0.08 + 0.10 = 0.18 | |
| 3 | 26.6 | 0.12 | = 0.18 + 0.12 = 0.30 | |
| . | . | . | . | |
| . | . | . | . | |
| . | . | . | . | |
| 69 | 374.3 | 1.70 | 46.47 | |
| 70 | 386.6 | 1.75 | 48.22 | p50 = 397.6 nm |
| 71 | 397.8 | 1.80 | 50.03 | |
| . | . | . | . | |
| . | . | . | . | |
| . | . | . | . | |
| 81 | 589.1 | 2.67 | 71.37 | |
| 82 | 605.6 | 2.75 | 74.12 | P75 = 610.8 nm |
| 83 | 622.2 | 2.82 | 76.94 | |
| . | . | . | . | |
| . | . | . | . | |
| . | . | . | . | |
| 90 | 913.7 | 4.14 | 100.00 | |
| Total | 22044.4 | 100.00 | | |

F) X-ray powder diffraction (XRD)
F1) XRD measurement

The X-ray diffraction pattern of the positive electrode active material powder examples as described herein below is collected with a Rigaku X-Ray Diffractometer Ultima 4 using a Cu Ka radiation source (40 kV, 40 mA) emitting at a wavelength of 1.5418 Å. The instrument configuration is set at: a 1° Soller slit (SS), a 10 mm divergent height limiting slit (DHLS), a 1° divergence slit (DS) and a 0.3 mm reception slit (RS). The diameter of the goniometer is 185 mm. For the XRD, diffraction patterns are obtained in the range of 40-80° (2θ) with a scan speed of 1° per min and a step-size of 0.02° per scan.

F2) Crystallite size calculation

The average crystallite size is determined by the XRD measurement of the positive electrode active material secondary particles. It has a good correlation with an average size of primary particle included in the positive electrode active material secondary particles. Therefore, the average crystallite size obtained by XRD is often used as a relative parameter to estimate the primary particle size of the secondary particles.

The average crystallite size of the secondary particles of the positive electrode active material examples as described herein below is determined according to the following steps:
Step 1) Collecting diffractogram of standard LaB₆ material (99.5%, Alfa Aesar, from Fisher Scientific) according to the XRD measurement described in F1.
Step 2) Collecting diffractogram of the positive electrode active material according to the XRD measurement described in F1.
Step 3) Performing peak integration each for peak LaB₆ from 20 of 47° to 51° and positive electrode active material from 20 of 42°-47°. The peak integration is conducted in Origin 2018b Version b9.5.5.409 and the baseline is set to straight line and area from 42.7° to 45.7°. From this step, integrated peak areas of LaB₆ and the positive electrode active material are obtained and labelled as A_{LaB}_{₆} and A_{activematerial}, respectively.

Step 4) Performing fitting to separate Ka1 and Ka2 contribution. The fitting is done each to the collected diffractogram of LaB₆ (from Step 1) and the positive electrode active material (from Step 2). The fitting can be done in any graphing and analysis software, given that the calculation constraints as describe in the calculation method can be implemented. In this invention, the fitting is assisted by a Solver tool, embedded in the Microsoft® Excel® for Microsoft 365 MSO (Version 2202 Build 16.0.14931.20648). The tool is used to fit peak function based on some preset conditions and objective. The preset conditions including fitting function, constraints, and input value table while objective is a cell containing SUMXMY2 formula. Each preset condition and objective are explained as follow:

### Fitting Function

Fitting function is according to the pseudo-Voigt equation, a mix of Gaussian and Lorentzian line shape. The equation is:

$$y = {y}_{o} + A [ {m}_{u} \frac{2}{π} \frac{w}{4 {( x - {x}_{c} )}^{2} + {w}^{2}} + ( 1 - {m}_{u} ) \frac{\sqrt{4 ln 2}}{\sqrt{π} w} {e}^{\frac{4 ln 2}{{w}^{2}} {( x - {x}_{c} )}^{2}} ]$$

with yₒ=offset, x_{c}=center position of the peak, A=peak area, w=peak width (full width half maximum), and mᵤ=profile shape factor. These five parameters are the variable cells set in the Solver tools.

### Constraints

Some relevant constraints are specified in the calculation following:
Ka1 and Ka2 peak width, wherein w_{Ka1}≤0.4° and w_{Ka1}=w_{Ka2}; Integrated area ratio between Ka1 and Ka2, wherein A_{Ka2}≤A Kₐ₁*0.5; Ka1 and Ka2 peak position, wherein Xc_{Ka1}=Xc_{Ka2}−d, wherein d can be calculated according to Rachinger equation (Schramm, R. E., Correction and calculations on an X-ray diffraction line profile: A computer program, National Bureau of Standards, 1971, p. 8-9):

$$d = 2 \{ {sin}^{- 1} ⌈ \frac{λ 2}{λ} sin θ ⌉ - {sin}^{- 1} ⌈ \frac{λ 1}{λ} sin θ ⌉ \}$$

Wherein, λ is wavelengths of Cu Ka=1.54178 Å, λ1 is wavelengths of Cu Ka1=1.54051 Å, λ2 is wavelengths of Cu Ka2=1.54433 Å (Nicol, A. W., Physicochemical methods of mineral analysis, Plenum Press, New York, 1975, p. 254), and θ is the half of the center point of the selected 2θ range in Step 3) (θ for LaB₆ is 49 0/2=24.5° and θ for the active material is 44.5°/2=22.25°). Therefore, the value of d is 0.129° for LaB₆, and 0.116° for the positive electrode active material.

### Input Value Table

Input value table is a set of initial data used as a starter to improve the fitting and obtain repeatable result. It involves prediction of parameter value based on estimation. Table 2.1 shows the example of input value table for EX1.1, an example of a positive electrode material according to the present invention.

TABLE 2.1
Example of input value table for EX1.1

| Parameter | Kα1 peak | Kα2 peak |
|---|---|---|
| y₀ | 0 | 0 |
| x_{c} | 44.3 | 44.4 |
| A | 14071.0 | 7035.5 |
| w | 0.2 | 0.2 |
| mᵤ | 0.5 | 0.5 |

In the calculation, y₀ offset is always zero since input data is linearly baselined to 0. The peak positions are organized to place Ka1 on the lower 20 than Ka2. mᵤ and w are set as 0.5 and 0.2, respectively. The XRD peak area in the range of 42°-47° is assumed to be a triangle shaped with 1.5° base and maximum intensity of the baselined peak as the triangle height. Ka1 area is ⅔ of the calculated total XRD peak area and Ka2 area is ⅓ of the calculated total XRD peak area.

### Objective

The minimum value of SUMXMY2 is set as the objective in the Solver calculation. This function returns the sum of squares of differences between two array values. In this case, the difference is between real and calculated values. Calculation is terminated when the goodness of fitting R² reached 99.5% or more. Otherwise, iteration will continue to reach the minimum value of the objective.

The diffractogram of LaB₆ is shown in FIG. 1. The example of XRD peak of EX1.1 after fitting process is shown in FIG. 2 (x-axis: 2θ, y-axis: intensity). The result of calculated parameter is shown in Table 2.2.

TABLE 2.2
Calculated parameter after fitting for EX1.1

| Parameter | Kα1 peak | Kα2 peak |
|---|---|---|
| y₀ | 0 | 0 |
| x_{c} | 44.32 | 44.43 |
| A | 14979.05 | 7489.53 |
| w | 0.37 | 0.37 |
| mᵤ | 0.65 | 0.56 |

From this step, maximum intensity of Ka1 peak each for LaB₆ and the positive electrode active material are obtained and labelled as I_{LaB6} and I_{active material}, respectively.

Step 5) Calculating integral breadth according to equation:

$${IB}_{LaB 6} = \frac{{A}_{L α B 6}}{{I}_{LaB 6}} \times \frac{2}{3}$$

$${IB}_{active maerial} = \frac{{A}_{active material}}{{I}_{active material}} \times \frac{2}{3}$$

From this step, integral breadths of LaB₆ and the positive electrode active material are obtained and labelled as IB_{LaB6} and IB_{active material}, respectively.

Step 6) Correcting IB of positive electrode active material from the instrument broadening according to equation:

$$β = \sqrt{{( {IB}_{active matetrial} )}^{2} - {( {IB}_{LaB 6} )}^{2}}$$

Wherein P is the corrected IB_{active material}.

Step 7) Calculating the average crystallite size of the secondary particles of the positive electrode active material (S2) by using a Scherrer equation:

$$τ = \frac{K \cdot λ}{β \cdot cos θ} ,$$

wherein τ is the average crystallite size in nm as calculated from XRD, λ is the X-Ray wavelength in nm, K is the Scherrer constant which set as 0.9, θ is x_{c} of positive electrode active material Ka1 in radians as obtained from Step 4, and β is the corrected IB_{active material} obtained from Step 6).

### EXAMPLES

The present invention is further illustrated in the following examples:

### Comparative Example 1

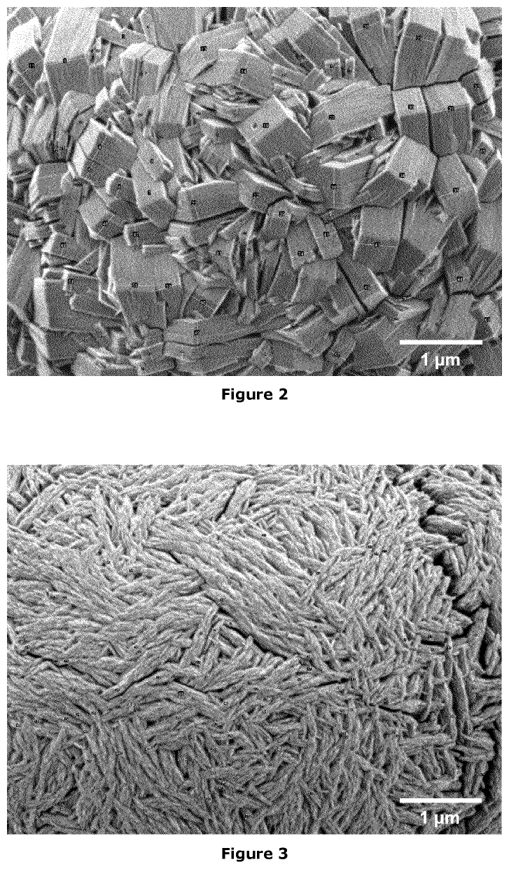

Positive electrode active material CEX1.1 was prepared through a solid-state reaction between a lithium source and a precursor according to the following steps:
1. Precursor A preparation: A starting solution was prepared by placing 2.0 L of DI water, 15 mL of 220 g/L NH₃(aq) in a 3.65 L reactor and adjusting the temperature in the reactor vessel to 65° C. and kept at this temperature throughout the process. pH of the starting solution was adjusted by adding 230 g/L NaOH_{(aq)} solution to a value of 12.9.
   Next, a precipitation reaction was performed by adding metal sulfate solutions of 129 g/L NiSO₄(aq), 80 g/L MnSO₄(aq), and 80 g/L CoSO₄(aq), 220 g/L NH₃(aq), and 230 g/L NaOH(aq) solution were, while mixing with a power density of around 30 kW/m³ for the first 20 hours and with a power density of around 10 kW/m³ for the rest of the process. The metal sulfate solutions were each added by using separate pumps through a static mixer. The amount of Ni:Mn:Co were 98:2:0 at the beginning of the process and gradually changing to 74.1:20.3:5.6 towards the end of the precipitation process. During the reaction a feed rate of the NaOH solution was adjusted so that a pH value of the reaction mixture in the reactor vessel was kept steady at 11.6 to 11.8 and a feed rate of the NH₃(aq) was adjusted so that a NH₃ concentration in the reaction mixture was kept steady at 8.0±1 g/L. After 100 min after the start of the reaction it was put on hold and the reaction mixture, i.e. an aqueous slurry, was taken out from the reactor vessel. Then 183 mL of the slurry and 1640 mL of a mother liquid was put back on the reactor and the precipitation was continued. A reactor sample of the reaction mixture was taken every two hours and the D50 was measured from it. The reaction was stopped when the D50 of the reactor sample reached approximately the target value of around 10 μm, a duration of the process was 56 h. A part of a liquid fraction of the reaction mixture was pumped out from the reactor during the process by using a concentrator to obtain a slurry with a solid content of 1100 g/L.
   The aqueous slurry of metal hydroxides obtained were filtered and washed with 220 g/L NaOH(aq) solution and 60° C. DI water. The filter cakes were dried in the oven at 120° C. for 12 hours to obtain precursor A having total metal composition of Ni_{0.85}Mn_{0.10}Co_{0.05}. FIG. 3 is a SEM image of Precursor A to obtain the average primary particle diameter of Precursor A.
2. Mixing: precursor A prepared from Step 1) was mixed with LiOH and Nb₂O₅ in an industrial blender to obtain a first mixture having 1 mol % Nb and lithium to metal ratio of 1.01.
3. Heating: the mixture from Step 2) was heated at 705° C. for 12 hours under an oxygen atmosphere, followed by grinding and sieving, to obtain CEX1.1.

Positive electrode active material CEX1.2 was prepared according to the same method as CEX1.1, except that the heating temperature in Step 3) was 755° C.

### Example 1

Positive electrode active material EX1.1 was prepared through a solid-state reaction between a lithium source and a precursor according to the following steps:
1. Precursor B preparation: Precursor B was prepared according to the same method as precursor A prepared in CEX1 except for keeping the temperature in the reactor vessel at 85° C.
2. Mixing: precursor B prepared from Step 1) was mixed with LiOH and Nb₂O₅ in an industrial blender to obtain a first mixture having 1 mol % Nb and lithium to metal ratio of 1.01.
3. Heating: the mixture from Step 2) was heated at 705° C. for 12 hours under an oxygen atmosphere, followed by grinding and sieving, to obtain EX1.1.

Positive electrode active material EX1.2 was prepared according to the same method as EX1.1, except that the heating temperature in Step 3) was 755° C.

### Comparative Example 2

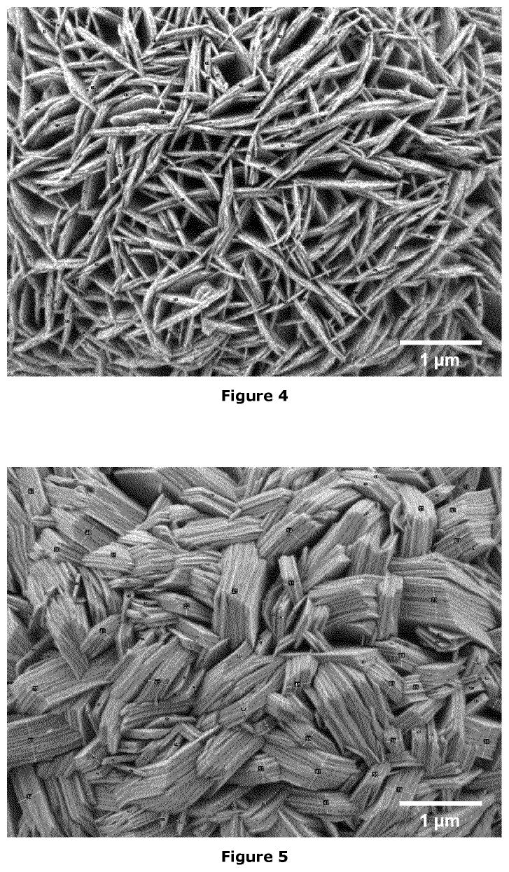

Positive electrode active material CEX2.1 was prepared through a solid-state reaction between a lithium source and a precursor according to the following steps:
1. Precursor C preparation: A starting solution was prepared by placing 6 L of DI water, 160 mL of 220 g/L NH₃(aq), and 100 mL of 440 g/L aqueous slurry comprising seeds particles of Ni_{0.94}Mn_{0.03}Co_{0.03}(OH)₂ having D50 of 5.0 μm were added in a 10 L reactor vessel and adjusting the temperature in the reactor vessel to 75° C. and kept at this temperature throughout the process.
   Next, a precipitation reaction was performed by adding 120 g/L metal sulfate solution comprising Ni, Mn, and Co (in a stoichiometric molar ratio, Ni:Mn:Co of 94:3:3), 220 g/L NH₃(aq), and 230 g/L NaOH(aq) solution, while mixing with a power density of around 30 kW/m³ for the first 6 hours and with a power density of around 20 kW/m³ for the rest of the process step. A feed rate of the metal sulfate solution was 135 mL/h in the beginning and increased continuously all the time to keep the particle growth rate constant at 0.4 μm/h. During the reaction a feed rate of the NaOH(aq) solution was adjusted so that a pH value of the reaction mixture in the reactor vessel was kept steady at 11.2±0.1 and a feed rate of the NH₃(aq) was adjusted so that a NH₃ concentration in the reaction mixture was kept steady at 5.0±1 g/L. A reactor sample of the reaction mixture was taken every two hours and the D50 was measured from it. The reaction was stopped when the D50 of the reactor sample reached approximately the target value of 10.0 μm, a duration of the process was 12 h. A part of a liquid fraction of the reaction mixture was pumped out from the reactor during the process by using an external concentrator and a solid content of the reaction mixture in the reactor vessel was around 390 g/L in the end of the process.
   The aqueous slurry of metal hydroxides obtained were filtered and washed with 220 g/L NaOH solution and 60° C. DI water. The filter cakes were dried in the oven at 120° C. for 12 hours to obtain precursor C.
   FIG. 4 is a SEM image of Precursor C to obtain the average primary particle diameter of Precursor C.
2. Mixing: precursor C prepared from Step 1) was mixed with LiOH, Nb₂O₅, and Al₂O₃ in an industrial blender to obtain a first mixture having 0.52 mol % Nb, 0.5 mol % Al, and lithium to metal ratio of 1.03.
3. Heating: the mixture from Step 2) was heated at 700° C. for 12 hours under an oxygen atmosphere, followed by grinding and sieving, to obtain a raw positive electrode active material.
4. Water treatment: the raw positive electrode material from Step 3) was immersed in water and dried to obtain CEX2.1.

Positive electrode active material CEX2.2 was prepared according to the same method as CEX2.1, except that the heating temperature in Step 3) was 720° C.

Positive electrode active material CEX2.3 was prepared according to the same method as CEX2.1, except that the heating temperature in Step 3) was 740° C.

### Example 2

Positive electrode active material EX2.1 was prepared through a solid-state reaction between a lithium source and a precursor according to the following steps:
1. Precursor D preparation: A starting solution was prepared by placing 6 L of DI water, 350 mL of 220 g/L NH₃(aq), and 400 mL of 440 g/L aqueous slurry comprising seeds particles of Ni_{0.94}Mn_{0.03}Co_{0.03}(OH)₂ having D50 of 5.0 μm were added in a 10 L reactor vessel and adjusting the temperature in the reactor vessel to 85° C. and kept at this temperature throughout the process.
   Next, a precipitation reaction was performed by adding 120 g/L metal sulfate solution comprising Ni, Mn, and Co (in a stoichiometric molar ratio, Ni:Mn:Co of 94:03:03), 220 g/L NH₃(aq), and 230 g/L NaOH(aq) solution, while mixing with a power density of around 30 kW/m3 for the first 6 hours and with a power density of around 20 kW/m3 for the rest of the process step. A feed rate of the metal sulfate solution was 540 mL/h in the beginning and increased continuously all the time to keep the particle growth rate constant at 0.5 μm/h. During the reaction a feed rate of the NaOH solution was adjusted so that a pH value of the reaction mixture in the reactor vessel was kept steady at 11.7±0.1 and a feed rate of the NH₃(aq) was adjusted so that a NH₃ concentration in the reaction mixture was kept steady at 12.0±1 g/L. A reactor sample of the reaction mixture was taken every two hours and the D50 was measured from it. The reaction was stopped when the D50 of the reactor sample reached approximately the target value of 10.0 μm, a duration of the process was 11 h. A part of a liquid fraction of the reaction mixture was pumped out from the reactor during the process by using an external concentrator and a solid content of the reaction mixture in the reactor vessel was around 180 g/L in the end of the process.
   The aqueous slurry of metal hydroxides obtained were filtered and washed with 220 g/L NaOH(aq) solution and 60° C. DI water. The filter cakes were dried in the oven with 120° C. for 12 hours to obtain precursor D.
   FIG. 5 is a SEM image of Precursor D to obtain the average primary particle diameter of Precursor D.
2. Mixing: precursor D prepared from Step 1) was mixed with LiOH, Nb₂O₅, and Al₂O₃ in an industrial blender to obtain a first mixture having 0.52 mol % Nb, 0.5 mol % Al, and lithium to metal ratio of 1.03.
3. Heating: the mixture from Step 2) was heated at 700° C. for 12 hours under an oxygen atmosphere, followed by grinding and sieving, to obtain a raw positive electrode active material.
4. Water treatment: the raw positive electrode material from Step 3) was immersed in water and dried to obtain EX2.1.

Positive electrode active material EX2.2 was prepared according to the same method as EX2.1, except that the heating temperature in Step 3) was 720° C.

Positive electrode active material EX2.3 was prepared according to the same method as EX2.1, except that the heating temperature in Step 3) was 740° C.

### Results

TABLE 3
Summary of the properties of precursor

| | | | | | Primary particle | |
|---|---|---|---|---|---|---|
| | Composition (at %) | | | | thickness (nm) | |
| Precursor | Ni | Mn | Co | D50 (μm) | p50 | p75 |
| A | 85 | 10 | 5 | 10.2 | 93.3 | 120.0 |
| B | 85 | 10 | 5 | 9.0 | 279.1 | 399.6 |
| C | 94 | 3 | 3 | 10.6 | 75.6 | 94.7 |
| D | 94 | 3 | 3 | 10.2 | 253.3 | 341.8 |

TABLE 4
Summary of the properties of positive electrode active material in examples and comparative examples

| | | | | | | | | | Specific surface area | |
|---|---|---|---|---|---|---|---|---|---|---|
| | | | | | | | | | (m²/g) | |
| | | | | | | | Total | | Before | After |
| | | Ni | Heating | S1 | S2 | | base | Moisture | water | water |
| Precursor | ID | (at %) | (° C.) | (nm) | (nm) | S1/S2 | (μmol/g) | (ppm) | treatment | treatment |
| A | CEX1.1 | 85 | 705 | 117 | 18.6 | 6.3 | 427 | 1982 | n.a. | n.a. |
| | CEX1.2 | 85 | 755 | 189 | 24.5 | 7.7 | 400 | 2040 | n.a. | n.a. |
| B | EX1.1 | 85 | 705 | 418 | 19.5 | 21.5 | 277 | 1409 | n.a. | n.a. |
| | EX1.2 | 85 | 755 | 363 | 23.1 | 15.7 | 271 | 1273 | n.a. | n.a. |
| C | CEX2.1 | 94 | 700 | 299 | 23.1 | 12.9 | 523 | 419 | 0.66 | 4.04 |
| | CEX2.2 | 94 | 720 | 348 | 28.6 | 12.2 | 521 | 322 | n.a. | n.a. |
| | CEX2.3 | 94 | 740 | 394 | 32.0 | 12.3 | 459 | 306 | 0.42 | 3.68 |
| D | EX2.1 | 94 | 700 | 386 | 24.3 | 15.9 | 420 | 284 | 0.28 | 3.21 |
| | EX2.2 | 94 | 720 | 419 | 26.7 | 15.7 | 443 | 295 | n.a. | n.a. |
| | EX2.3 | 94 | 740 | 475 | 29.1 | 16.3 | 402 | 276 | 0.22 | 3.21 |

Table 3 summarizes properties of precursor. Precursor B and precursor D show significantly thicker primary particle in comparison with precursor A and precursor C as indicated by p50 and p75 number. Each of precursor A to D is lithiated into positive electrode active material whose properties are summarized in Table 4.

CEX1.1, CEX1.2, EX1.2, and EX1.2 have the same metal composition, i.e., Ni:Mn:Co=85:10:5 (at %). It is observed that the ratios (S1/S2) of primary particle size as measured by SEM image (S1) to crystallite size as measured by XRD (S2) are bigger for EX1.1 and EX1.2 in comparison with CEX1.1 and CEX1.2. In particular, the ratios (S1/S2) of EX1.1 and EX1.2 are bigger than 13 whereas the ratios (S1/S2) of CEX1.1 and CEX1.2 are smaller than 13. This high ratio of S1/S2 is linked with the lower total base and absorption of moisture during exposure to the atmosphere. The total base and moisture uptake indicating unwanted surface impurity which cause problem during application of positive electrode active material in an electrochemical cell, such as gelation during slurry formation and gassing during cycling.

The same observation is applied for CEX2.1 to CEX2.3 with EX2.1 to EX2.3. CEX2.1 to CEX2.3 and EX2.1 to EX2.3 have the same metal composition, i.e., Ni:Mn:Co=94:3:3 (at %). EX2.1 to EX2.3 prepared from precursor D exhibit higher S1/S2 ratio in comparison with CEX2.1 to CEX2.3 and accordingly a lower total base and moisture content. In addition to the advantage in lower total base and moisture content, the specific surface areas of EX2.1 and EX2.3 are well below 4.0 m²/g in comparison with CEX2.1 and CEX2.3 after contacting the positive electrode active material with water. Even before contacting the positive electrode active material with water, the specific surface areas of EX2.1 and EX2.3 are lower than the specific surface areas of CEX2.1 and CEX2.3. The specific surface areas of EX2.1 and EX2.3 treated with water are around 3.2 m²/g. The low surface area is preferable to prevent moisture and carbon uptake when a positive electrode active material is exposed to air, and to reduce the risk of side reaction with electrolyte in the battery.

1-13. (canceled)

14. A positive electrode active material for lithium-ion batteries, wherein the positive electrode active material comprises secondary particles comprising primary particles,
wherein the primary particles have an average primary particle size (S1) as determined by SEM image analysis,
wherein the positive electrode active material has an average crystallite size (S2) as determined by X-Ray Diffraction measurement,
wherein S1/S2 is at least 13,
wherein S2 ranges from 5 nm to 50 nm, and
wherein the positive electrode active material has been treated with an aqueous solution.

15. The positive electrode active material according to claim 14, wherein S1/S2 is between 15 and 40.

16. The positive electrode active material according to claim 14, wherein S1/S2 is between 17 and 30.

17. The positive electrode active material according to claim 14, wherein S1 ranges from 100 nm to 1000 nm.

18. The positive electrode active material according to claim 14, wherein S2 ranges from 10 nm to 40 nm.

19. The positive electrode active material according to claim 14, wherein the positive electrode active material comprises Li, M′, and oxygen, wherein M′ comprises:
Ni in a content x, wherein x≥60.0 at %, relative to M′;
Co in a content y, wherein 0.0≤y≤30.0 at %, relative to M′;
Mn in a content z, wherein 0.0≤z≤30.0 at %, relative to M′;
D in a content a, wherein 0.0≤a≤5.0 at %, relative to M′, wherein D is at least one element selected from the group consisting of Al, B, Ba, Ca, Cr, Fe, Mg, Mo, Nb, S, Si, Sr, Ti, Y, V, W, Zn, and Zr;
wherein x+y+z+a is 100.0 at %

20. The positive electrode active material according to claim 19, wherein x≥70 at. %, relative to M′.

21. The positive electrode active material according to claim 19, wherein x≥80 at. %, relative to M′.

22. The positive electrode active material according to claim 19, wherein 0<y≤10 at. %, relative to M′.

23. The positive electrode active material according to claim 19, wherein 0<z≤15 at. %, relative to M′.

24. The positive electrode active material according to claim 19, wherein a median size D50 of the secondary particles is at least 2.0 μm and at most 15.0 μm, as determined by laser diffraction particle size analysis.

25. A battery comprising the positive electrode active material according to claim 14.

26. An electric vehicle or a hybrid electric vehicle comprising the battery according to claim 25.
